(19) United States
(12) Patent Application Publication
(10) Pub. No.: US 2026/0149687 A1
(43) Pub. Date: May 28, 2026

(54) AUTOMATION SYSTEM HAVING A COMMUNICATION INFRASTRUCTURE

(71) Applicant: Beckhoff Automation GmbH, Verl (DE)

(72) Inventors: Torsten Förder, Lemgo (DE); Daniel Kerkhoff, Verl (DE); Dirk Janssen, Verl (DE)

(21) Appl. No.: 19/448,256

(22) Filed: Jan. 14, 2026

Related U.S. Application Data
(63) Continuation of application No. PCT/EP2024/060728, filed on Apr. 19, 2024.

(30) Foreign Application Priority Data
Jul. 27, 2023 (DE) 10 2023 119 975.7

(51) Int. Cl. H04L 51/56; H04L 45/74

(52) U.S. Cl. CPC H04L 51/56; H04L 45/74

(57) ABSTRACT

An automation system has communication subscribers, each of which is connected to at least one message broker via a communication link. A first communication subscriber, which has subscribed to messages under a first topic name, publishes an availability message indicating the subscriber is providing a service associated with the first topic name. Each further communication subscriber receives a copy of the availability message with a first return route description comprising route section designations for route sections traveled starting from the first communication subscriber. A second communication subscriber publishes a request message for the service under the first topic name, using the first return route description as the delivery route to the first communication subscriber. The delivery route is reduced by the route section designation of the route section covered during transmission from the second communication subscriber to the first communication subscriber, via the communication links to the message broker.

### CROSS-REFERENCE TO RELATED APPLICATIONS

This patent application is a continuation of International Patent Application No. PCT/EP2024/060728, filed Apr. 19, 2024, entitled “Automation System with a Communication Infrastructure,” which claims the priority of German patent application No. DE 10 2023 119 975.7, filed Jul. 27, 2023, entitled “Automatisierungssystem mit einer Kommunikationsinfrastruktur,” each of which is incorporated by reference herein, in the entirety and for all purposes.

### TECHNICAL FIELD

The invention relates to a communication infrastructure for transmitting messages between communication subscribers in an automation system.

### BACKGROUND

Automation systems generally comprise a large number of communication subscribers. The transmission of messages between the communication subscribers may be embodied in such a way that one or a plurality of communication subscribers offer one or a plurality of services for other communication subscribers, wherein the service of the communication subscriber is used by the other communication subscriber via the communication infrastructure of the automation system.

As a service, the communication subscriber may make information available to the other communication subscriber regularly, sporadically or when certain conditions are met. Alternatively, the information may also be provided by the communication subscriber upon issuing a request to the service by the other communication subscriber.

A service of the communication subscriber may also be that the other communication subscriber requests actions from the communication subscriber. The actions are then carried out by the service of the communication subscriber and, as the case may be, responded to by transmitting a result to the other communication subscriber.

Actions may be, for example, creating, reading, modifying or deleting variables or variable values. However, actions may also be commands that the communication subscriber is to carry out in order to control the automation system, such as stopping a movement or renewing a software component within the automation system.

Services may provide simple variable values as information. However, services may also be representations in the form of objects as instances of certain complex types or classes. The instantiation of an object of a certain class then corresponds to the creation of a complex variable value. In contrast to simple variable values, complex variable values may also be used to carry out actions that go beyond creating, reading, modifying or deleting. Such actions may then be described with the aid of the type or class of the object instance.

Services may also provide meta information, which, like simple or complex variable values, may be requested as information and may also be linked to actions. For example, a service may provide meta information about the type or class of the service's variables or the type or class of variables that may be created for the service and which instances are currently available. Details on the types or classes may also be provided as information.

In a topology of the communication infrastructure in the automation system in which messages are transmitted between the communication subscribers via directly networked communication connections, the number of communication connections grows quadratically with the number of communication subscribers.

If, on the other hand, the communication infrastructure in the automation system comprises a message broker via which the communication subscribers are connected for message transmission, the number of communication connections required only increases linearly with the number of communication subscribers. With the aid of an intermediate message broker, the configuration effort may also be reduced and the resources required to set up and operate the communication connections may also be reduced.

Various approaches for message transmission with the aid of intermediary message brokers are known from the state of the art. One possible approach is the “MQTT version 5.0” standard (https://docs.oasis-open.org/mqtt/mqtt/v5.0/mqtt-v5.0.html).

In the “MQTT version 5.0” standard, the process of transmitting messages from the communication subscribers to the message brokers is referred to as publishing.

The published message contains a topic name. Topic names are also abbreviated as topics or referred to individually as topics. The topic name usually consists of a sequence of topic elements at different topic levels, which are separated by topic level separators.

The topic levels are organized hierarchically in a topic tree, in which any number of other topic levels may be subordinate to each topic level. At least one topic level is not itself subordinate to any other topic level. Topic levels that are not subordinate to any other topic level are referred to as the roots of the topic tree.

In the “MQTT version 5.0” standard, the communication subscribers inform the message brokers which topic names of the published messages the communication subscribers are interested in. This process is referred to as subscribing.

Communication subscribers may subscribe to individual topic names or partial trees of topic trees. Subscribing to partial trees is done by specifying a topic filter. A topic filter is a topic name in which individual and/or several consecutive topic levels are replaced by placeholders.

When transmitting messages on the basis of the publish-subscribe principle, the communication subscriber does not need to know to which other communication subscribers the message is to be transmitted. This knowledge is shifted to the message broker. The message broker keeps a list of which communication subscriber has subscribed to which topic names or which communication subscriber has subscribed to which topic filters.

The forwarding of a message to a plurality of interested communication subscribers by the message broker means that the publishing communication subscriber usually only has to transmit the message to the message broker once. In an automation system with directly networked communication connections, however, the message must be transmitted several times by the publishing communication subscriber if more than one other communication subscriber is to receive the message.

The forwarding of a message by the message broker further ensures that information from communication subscribers with limited resources may be made available to many other communication subscribers. For example, a temperature measurement from a sensor may be shown on different displays at the same time. Conversely, the message broker may provide one communication subscriber with information from many other communication subscribers. For example, the temperature measurements of many distributed sensors may be shown simultaneously on one display.

The “MQTT version 5.0” standard further describes how an interaction between two communication subscribers takes place in the message brokering based on the publish-subscribe principle. An interaction consists of a message requesting an action from another communication subscriber and, as the case may be, a message with information about the response.

In accordance with the “MQTT version 5.0” standard, the communication subscriber publishes a request message with a request for action with reference to a topic name. Communication subscribers who have subscribed to messages for the topic name with the message broker then respond to the request message.

The request message may also specify the topic name to which the response should be published, which is referred to as the response topic in the standard. The response topic is transmitted with the message. The request message may also contain correlation information (correlation data).

Communication subscribers which react to a request message and perform an action may publish a response message with the message broker, for example with a result in the form of a reaction, under a topic name. The communication subscribers repeat the correlation information from the request message in the response message. The correlation information allows for the requesting communication subscriber to assign a response message to a preceding request message. Before a communication subscriber publishes the request message, the communication subscriber subscribes to the response message with the message broker.

EP3386171B1 describes a method in which only the communication subscribers that request an action via a request message are directly connected to the message broker. The communication subscribers that perform an action and, as the case may be, send back a response message as a reaction, on the other hand, are connected to the message broker via an adapter.

A request message from a communication subscriber and a response message from an adapter are based on the same protocol. However, a further protocol may also be used for the interaction between the adapter and the responding communication subscriber. The adapter thus serves as a translator between the protocols.

In EP3386171B1, each adapter is assigned a unique adapter identification which is used by the communication subscribers to address a request message. The request message for an action then contains a so-called Uniform Resource Identifier (URI), which in turn contains an adapter identification and a variable name. The message broker may use the adapter identification to deliver the message to the desired communication subscriber.

EP3386171B1 further describes that a network of message brokers may also be used in the automation system in order to forward messages. The communication subscribers or the adapters only need to be connected to a single message broker in the network in order to subscribe to the message transmission. The network of message brokers is configured in such a way that the adapter identification from the request messages is sufficient to deliver the request messages to the desired adapter via the network of message brokers. Each message broker requires information about which adapters comprising which adapter identifications are connected to the message broker directly or indirectly via other message brokers.

EP3523927B1 discloses a further approach for message brokering with the aid of an intermediate message broker in which the message broker creates an availability message for a service, which specifies the topic under which a request for the service is expected, in the form of an order topic. The communication subscriber then does not need to configure how messages are to be addressed to the service, but receives the information in the form of the order topic from the availability message from the message broker.

The “Sparkplug 3.0.0” specification explains the embodiment of a topic tree in a message broker in order to allow for a large number of communication subscribers to jointly interact via the message broker. For interactions via the message broker, the communication subscribers specify the topics under which the communication subscribers offer the services, the topics for which the communication subscribers listen for request messages and the topics under which the communication subscribers then expect response messages. In the “Sparkplug 3.0.0” specification, identities are used on the topic levels to address communication subscribers.

In a network with a plurality of message brokers, switching bridges are usually implemented that comprise a plurality of communication subscribers, each of which is connected to a message broker from the network. The switching bridge may publish a message that is published with a message broker that is connected to a communication subscriber of the switching bridge with further message brokers as a message copy via the further communication subscribers of the switching bridge.

The switching bridge may be embodied in such a way that only messages on certain topics are forwarded from one message broker to further message brokers. Furthermore, the switching bridge may also change the topic of the message copy before forwarding. The change of topic may, for example, refer to which communication subscriber of the switching bridge has received the message or to which communication subscriber the switching bridge forwards the message copy.

When using switching bridges, message copies may also be forwarded to other message brokers, even though none of the communication subscribers connected to the other message brokers have subscribed to the topic of the message, which takes up unnecessary transmission bandwidth.

Furthermore, undesired feedback may occur if, for example, a circle of communication connections between the message brokers is closed topologically using switching bridges. If, as in the “MQTT version 5.0” standard, the message broker is not embodied to recognize message copies as copies of the original message, the message may be delivered to a communication subscriber multiple times.

As the switching bridge also acts as a communication subscriber, the switching bridge may also again forward a message copy that the switching bridge has already forwarded. This may result in endless cycles and infinite multiplication of messages, which may overload the communication infrastructure and lead to malfunctions and failures. Problems with switching bridges preferably occur when the switching bridges are topic to differing administrative controls.

A switching bridge may also be an integral part of a message broker, wherein the message broker has a communication link with the various communication subscribers and also comprises communication subscribers as a switching bridge, which in turn are connected to other message brokers via communication links.

For the sake of simplicity, it is assumed in the following that a switching bridge switches messages between two message brokers. However, the descriptions of a switching bridge that switches messages between two message brokers also apply to a switching bridge that switches messages between more than two message brokers.

Nowadays, the communication infrastructure in the automation system often crosses organizational boundaries and may be under the control of different legal or natural persons. To allow for the various natural or legal persons to act as autonomously as possible, it is particularly advantageous for the communication infrastructure if the change in one part of the communication infrastructure or for individual communication subscribers entails as few changes as possible for the other parts of the communication infrastructure or the further communication subscribers.

### SUMMARY

The invention provides an improved automation system in which consistent and efficient message transmission is allowed for within an automation system's communication infrastructure, even a complex one, which may be easily configured and maintained and, if required, changed with little effort.

According to an aspect, an automation system comprises a communication infrastructure having a plurality of communication subscribers, each of which is connected to at least one message broker via a communication link. The communication subscribers are embodied to publish messages under topic names or to subscribe to messages under topic names with the message broker, wherein the communication subscribers have a subscription to availability messages with the message broker, which indicate that a communication subscriber is providing a service. The availability messages each comprise initial return route descriptions which, during transmission between the communication subscribers via the communication connections to the message broker, are each extended by a route section designation for the route sections covered.

An interaction between the communication subscribers takes place in which at least a first communication subscriber, which has subscribed to messages under a first topic name with the message broker, publishes an availability message under the first topic name with the message broker, which indicates that the first communication subscriber is providing a service assigned to the first topic name, each further communication subscriber receiving a message copy of the availability message with a first return route description, which comprises the route section designations for the route sections covered, starting from the first communication subscriber, in which at least one second communication subscriber publishes a request message for the service under the first topic name with the message broker, the second communication subscriber using the first return route description of the message copy of the availability message of the service as the delivery route in the request message to the first communication subscriber, the delivery route of the request message being reduced by the route section designation of the route section covered in each case during transmission from the second communication subscriber to the first communication subscriber via the communication links to the message broker.

### EXAMPLES

The second communication subscriber may subscribe to messages under a second topic name with the message broker. The request message may comprise a second return route description, which is extended by the route section designation of the route section traveled during transmission from the second communication subscriber to the first communication subscriber via the communication links to the message broker. The first communication subscriber may publish a response message from the service to the request message under the second topic name with the message broker, wherein the first communication subscriber uses the second return route description of the request message as the delivery route in the response message to the second communication subscriber, wherein the delivery route of the response message is reduced by the route section designation of the traveled route section during transmission from the first communication subscriber to the second communication subscriber via the communication connections to the message broker.

The availability message may comprise first metadata and first message content, wherein the first metadata comprises the first topic name, the first return route description and unique value, and wherein the first message content comprises a service type and optionally a service version.

Each communication subscriber may comprise a subscriber message broker connected to the message broker via the associated communication link, wherein each subscriber message broker is associated with a broker designation that uniquely identifies the subscriber message broker with respect to the other subscriber message brokers associated with the message broker.

The communication subscriber may comprise a service and/or an application, each of which is connected to the subscriber message broker of the communication subscriber via a communication link, wherein the service and/or the application are embodied to publish messages under topic names or subscribe to messages under topic names at the subscriber message broker of the communication subscriber. In the communication subscriber, each service may be assigned a service name and each application may be assigned an application name that uniquely identifies the service or application in the communication subscriber.

The communication links of the communication subscribers with the message broker may each be switching bridges, each switching bridge being associated with a bridge identifier that uniquely identifies the switching bridge with respect to the further switching bridges associated with the message broker. The switching bridges may have subscriptions and translation tables, wherein the switching bridges are configured to use the subscriptions to subscribe to topic names to be forwarded by the switching bridges at the subscriber message brokers associated with the switching bridges, and wherein the switching bridges are configured to use the translation tables to modify the topic names during transmission.

The message broker may have a topic tree in which a distinction is made between topic names that contain a delivery route and those that do not. The delivery route may be part of the topic name in each case. Availability messages may also be marked in the topic tree.

The automation system may extend across organizational and geographical boundaries, wherein the parts of the automation system may be changed autonomously by the respective organization without it being necessary for further communication subscribers or message brokers of the automation system to be aware of the change in order to continue to be able to use services from the changed part of the automation system or to continue to be able to offer services for the changed part of the automation system.

In the automation system, the communication subscribers learn without prior configuration which services required by the communication subscribers may be reached and how, or how a request message may be transmitted. Neither the communication subscribers nor the message brokers need to know which communication subscribers and services are available at which point in the communication infrastructure in order to be able to select transmission routes.

It is not necessary to use unique identifiers within a shared topic tree of the communication infrastructure in order to address messages correctly. The assignment of unique identifiers requires a central registry to prevent the duplication of identifiers. The need for such a central registry would prevent the autonomy of different organizations to independently change parts of the communication infrastructure under their administration, for example to integrate new communication subscribers and/or message brokers.

Furthermore, topological circuits within the communication infrastructure of the automation system, such as those that occur in the event of feedback with message duplication, have no negative effects. The redundant communication connections contribute to the stability and availability of the communication infrastructure in that interruptions to individual communication connections may be automatically compensated for by using the redundant communication connection that may be available.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a message within the framework message broker based on the publish-subscribe principle.

FIG. 2 shows a topic tree.

FIG. 3 shows messages for an interaction between communication subscribers.

FIG. 4 shows return route descriptions.

FIG. 5 shows an availability message.

FIG. 6 shows a request message.

FIG. 7 shows a response message.

FIG. 8 shows the structure of an automation system having communication subscribers and a message broker.

FIG. 9 shows a topic tree from the point of view of the message broker in the automation system from FIG. 8.

FIG. 10 shows a topic tree from the perspective of a subscriber message broker in a communication subscriber of the automation system shown in FIG. 8.

FIG. 11 shows subscription lists and translation tables for a switching bridge in the automation system shown in FIG. 8.

FIG. 12 shows the process in the automation system of FIG. 8 when a service of a communication subscriber publishes an availability message.

FIG. 13 shows the process in the automation system of FIG. 8 in which applications publish request messages in communication subscribers.

FIG. 14 shows the process in the automation system of FIG. 8 when a service in the communication subscriber publishes response messages in response to the request messages.

### DETAILED DESCRIPTION

In an automation system having a communication infrastructure that comprises one or a plurality of message brokers, message transmission is based on the publish-subscribe principle.

Communication subscribers publish (publishing) or subscribe (subscribing) messages with the message broker.

A message contains a topic name, hereinafter also referred to as topics or individually as topic, which usually consists of a single topic element or a sequence of topic elements from different topic levels separated by topic level separators.

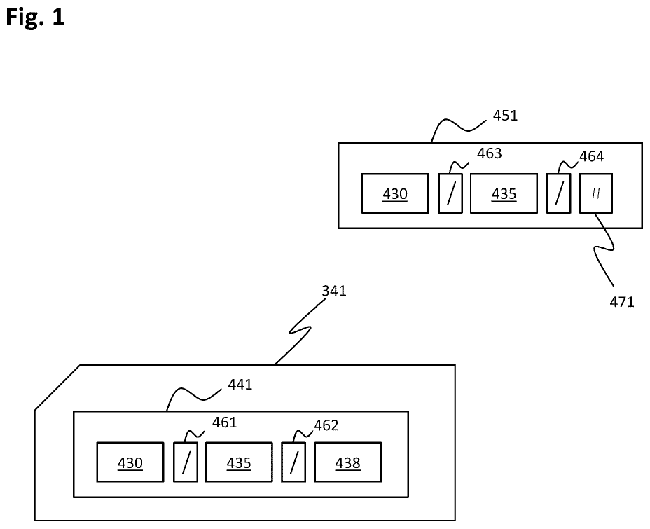

An exemplary structure of a message 341 which is published by a communication subscriber with a message broker is shown in FIG. 1. The message 341 has a topic name 441 which comprises the first topic element 430, the second topic element 435 and the third topic element 438 with intermediate first level separators 461 and second level separators 462.

The topic levels of the topic elements are organized hierarchically in a topic tree, wherein any number of additional topic levels may be subordinate to each topic level. Topic levels that are not subordinate to any other topic level form the roots of the topic tree.

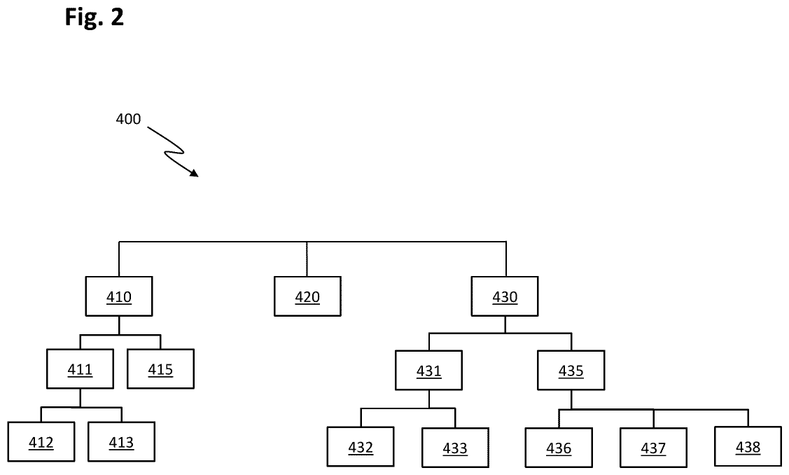

An exemplary structure of a topic tree 400 is shown in FIG. 2, in which the topic tree 400 grows from top to bottom. The topic tree 400 contains three topic elements as roots in a topic level, which contains the first topic element 430 of the topic name 441 of the message 341 as well as a fourth topic element 410 and a fifth topic element 420.

The next topic level includes four topic elements, which are the second topic element 435 of topic name 441, hierarchically subordinate to the first topic element 430 of topic name 441, a sixth topic element 411 and a seventh topic element 415, hierarchically subordinate to the fourth topic element 410, and an eighth topic element 431, hierarchically subordinate to the first topic element 430.

The subsequent topic level comprises seven topic elements comprising the third topic element 438 of topic name 441, which is hierarchically subordinate to the second topic element 435 of topic name 441, and a ninth topic element 412 and a tenth topic element 413, which are hierarchically subordinate to the sixth topic element 411, an eleventh topic element 432 and a twelfth topic element 433, which are hierarchically subordinate to the eighth topic element 431, and a thirteenth topic element 436 and a fourteenth topic element 437, which are hierarchically subordinate to the second topic element 435.

The communication subscribers may subscribe to individual topic names or partial trees of the topic tree. Subscribing to partial trees is carried out by specifying a topic filter. A topic filter is a topic name in which individual and/or a plurality of consecutive topic levels are replaced by placeholders.

An exemplary structure of a topic filter 451 is furthermore shown in FIG. 1. The topic filter 451 comprises the first topic element 430 and the second topic element 435 with an intermediate third level separator 463. After the second topic element 435, a fourth level separator 464 is arranged, which is followed by a placeholder 471. The placeholder 471 thus covers the thirteenth topic element 436, the fourteenth topic element 437 and the third topic element 438, which are hierarchically subordinate to the second topic element 435.

In the case of messaging based on the publish-subscribe principle, interaction takes place between the communication subscribers in which communication subscribers publish request messages and, as the case may be, receive response messages.

A communication subscriber publishes a request message for an action on a topic name 441 to the message broker. Communication subscribers which have subscribed to messages for the topic name 441 at the message broker then respond to the request message. The request message may also specify the topic name 441 to which the response is to be published, which is referred to below as the response topic. The response topic is transmitted with the request message. Correlation information (correlation data) may also be specified in the request message.

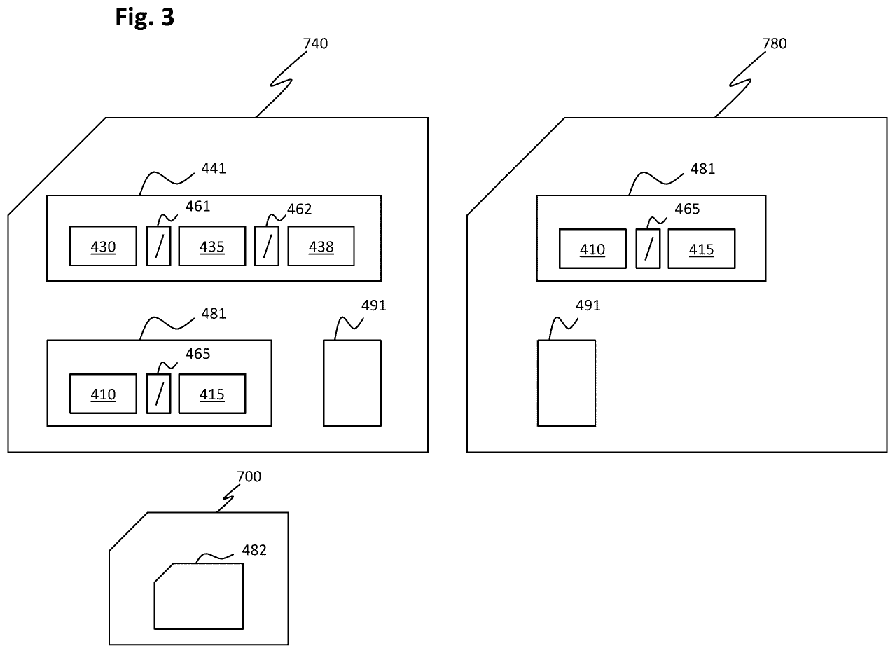

FIG. 3 shows an example of the messages in an interaction between communication subscribers in the automation system. A communication subscriber publishes a request message 740 to the message broker in response to the topic name 441, which is already shown in FIG. 1 and comprises the first topic element 430, second topic element 435 and third topic element 438 with the intermediate first level separator 461 and second level separator 462. The request message 740 further includes a response topic 481 that includes the fourth topic element 410 and the seventh topic element 415 with an intermediate fifth level separator 465. Further, the request message 740 includes correlation information 491.

The communication subscribers which react to a request message and carry out an action may publish a response message with the message broker under a topic name, for example with a result as a reaction. The communication subscribers repeat the correlation information from the request message in the response message. The correlation information makes it possible to assign a response message from a previous request message to the requesting communication subscriber. Before a communication subscriber publishes the request message, the communication subscriber subscribes to the topic of the response message with the message broker.

FIG. 3 shows a response message 780 with the response topic 481, which is published by a responding communication subscriber at the message broker within the framework of the interaction. The response message 780 also contains the correlation information 491.

The communication subscribers also use a message on a topic to indicate that a service is provided and that request messages regarding the service are expected. Such a message is referred to below as an availability message for the service. The designation of the topic name under which a request for the service is expected is referred to as the order topic.

FIG. 3 shows an availability message 700 with an order topic 482. The availability messages are sent by the message brokers to interested communication subscribers via the communication infrastructure.

In an automation system with a network of message brokers, messages are delivered using route descriptions. A route description assigned to a message specifies via which message brokers and/or which communication links between the message brokers the message is to be forwarded.

The availability messages 700 are used to determine the route description. The availability message 700 then contains an additional field, which is referred to as the return route description and describes the transmission route back to the service.

Before the availability message 700 is sent by the service, the return route description does not contain a value. During the transmission to the next message broker or a communication subscriber, the return route description is extended by the name of the route section covered during the transmission, which is referred to below as the route section name. The extension of the return route description may be carried out before, during or after the transmission to the next message broker or a communication subscriber.

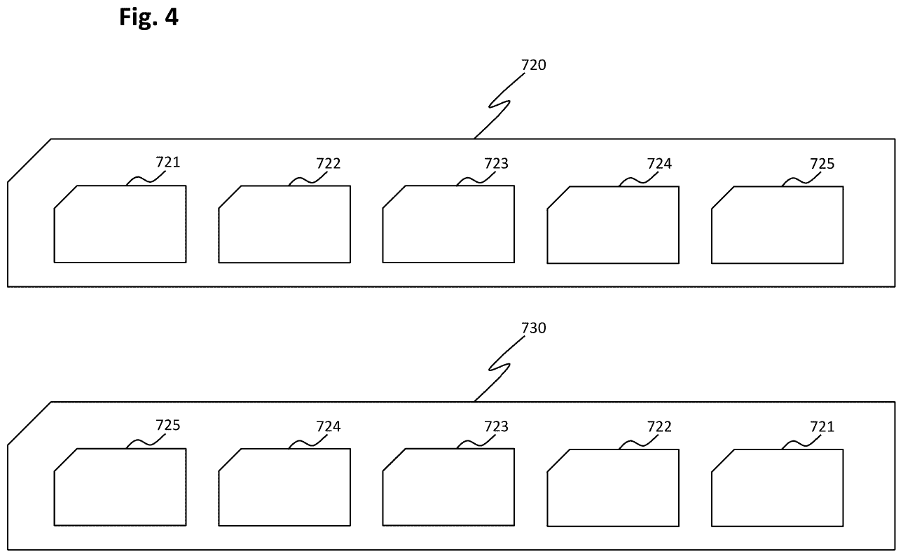

The route section designation may be appended to the end of the current value of the return route description. Alternatively, the route section designation may also be placed at the beginning of the value of the return route description. FIG. 4 shows examples of the two alternatives.

A first return route description 720 comprises first to fifth route section designations 721-725, wherein the order is first route section designation 721, second route section designation 722, third route section designation 723, fourth route section designation 724, and fifth route section designation 751.

A second return route description 730 again comprises first to fifth route section designations 721-725, wherein the order is fifth route section designation 725, fourth route section designation 724, third route section designation 723, second route section designation 722, and first route section designation 721.

In both embodiments, the route section designations in the return route description are ordered and separated from each other in such a way that the individual route section designations may be clearly determined from the return route description.

The availability message 700 may be delivered by the network of message brokers to a plurality of communication subscribers, as the case may be, if a plurality of communication subscribers is interested in the availability of the service. The distribution of the availability message 700 to a plurality of communication subscribers may take place automatically if the communication subscribers have previously subscribed to the topic of the availability message 700 from the message broker. Different services may use the same topic or different topics for the availability messages 700.

When distributing the availability message 700 to a number N of interested communication subscribers, N copies of the availability message 700 must also have been made after the complete delivery, which were delivered via N different routes. Each communication subscriber receives a copy of the availability message 700, wherein the message content of the availability message 700 is identical, but the return route description in each copy is individual.

The availability message 700 of the service with the associated individual return route description is used by the communication subscriber to send request messages 740 to the respective service. The request message 740 is assigned information in the form of a separate field or as part of a field about the route via which the request message 740 is to be delivered to the service. This information is referred to below as the delivery route.

The communication subscriber uses the return route description of the availability message 700 as the start value for the delivery route of the request message 740. The communication subscriber selects the transmission route based on the route section designations in the start value of the delivery route.

The value of the delivery route is in this context reduced by the route section designation of the route section traveled during the transmission during the transmission to the next message broker or a communication subscriber. The reduction of the delivery route may be carried out before, during or after the transmission to the next message broker or a communication subscriber.

The delivery route then only contains the route section designations of the parts of the transmission route via which the request message 740 still has to be transmitted. The order of the route section designations in the delivery route specifies which is the next route section designation.

When the request message 740 has reached the message broker that is directly connected to the communication subscriber offering the service, the value of the delivery route is empty or no longer available. The request message 740 has then reached its destination.

The structure of the delivery route corresponds to the structure of the return route description. If, when transmitting the availability message 700, the value of the return route description was extended at the front by adding further route section designations, then the foremost route section designation must be selected and reduced for the transmission from the delivery route. Similarly, if the value of the return route description in the availability message 700 has been extended by adding further route section designations, the rearmost route section designations must be selected and reduced for the transmission from the delivery route.

The values of the route section designations for return route descriptions or delivery routes may be determined automatically in various ways.

The route section designations may be determined by the respective message broker to which a communication subscriber or a further message broker establishes a communication connection, i.e. by the message broker that accepts the communication connection.

The message broker may assign a unique value to the communication connection, for example by assigning a next free value to the communication connection when accepting the communication connection.

Also, fixed values may be assigned to the route section designations. Such values may, for example, be the value that is assigned to the communication subscriber or to the message broker that establishes the communication connection to the next message broker. The values are assigned in such a way that the values are unique, at least from the perspective of the message broker involved in the communication link.

Furthermore, values for the communication links between communication subscribers and message brokers or neighboring message brokers may also be used as route section designations. A communication link may also be assigned a separate value for each of the two transmission directions. In the case of a return route description, the values of the opposite transmission direction must always be used when extending the value for the return route description so that the correct transmission direction is specified for the delivery route based on the return route description when the next transmission section is selected.

Names or numbers or a mixture of names and numbers may be used as the value. The route section designation only needs to be unique in a locally limited part of the communication infrastructure. This allows for redesigning parts of the communication infrastructure locally and autonomously without having to inform further parts of the communication infrastructure.

In order to allow for a service to respond to a communication subscriber to a request message 740, the communication subscriber adds a return route description field to the request message 740 in a manner analogous to the construction of an availability message 700 by a message broker, which is initially empty or absent and then contains a value when it reaches the service, which may then be used by the service to provide a response message 780 with the value for the delivery route to the communication subscriber sending the request message 740. The value for the return route description of the request message 740 is generated in the same way as the return route description for the availability message 700.

If communication subscribers learn of a service with the aid of an availability message 700 and then send a request message 740 to the service and optionally receive a response message 780 from the service, it is not necessary to wait for a further availability message 700 before sending a further request message 740 from the communication subscriber to the service. The delivery route to the service is already known to the communication subscriber. The communication subscriber may use the known delivery route for any number of further request messages 740 to the service.

If parts of the communication infrastructure are reconfigured after an availability message 700 has been received, the delivery route based on the return route description of the availability message 700 may change. The communication subscribers may, for example, recognize the delivery route error, if a response message from the service to a request message is not received within an expected response time.

In order to ensure that services may still be reached in the event of a reorganization of the communication infrastructure, services may send additional availability messages periodically or on demand, for example with the help of retain messages from the message brokers in accordance with the “MQTT version 5.0” standard.

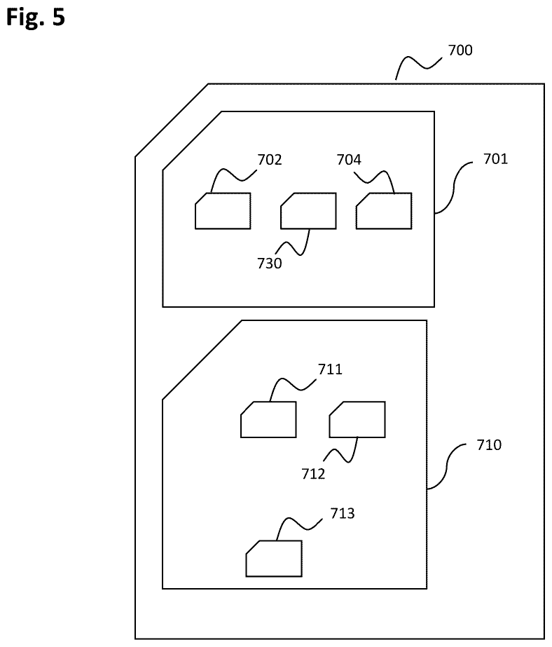

As shown in FIG. 5, an availability message 700 comprises first metadata 701, also referred to as “header” or “properties”, and a first message content 710, also referred to as “payload”. The first metadata 701 comprises a first topic name 702, a first return route description 730 and optionally a unique value 704. The unique value 704 may, for example, be generated using a method from the standard RFC 4122 “Universally unique Identifier UUID URN Namespace”.

The first message content 710 of the availability message 700 describes the service. On the basis of the service description, the communication subscribers may then decide whether they want to use the service. The communication subscribers send request messages 740 to the service and may expect response messages 780.

The first message content 710 of the availability message 700 describes a service type 711, which makes the type of service offering recognizable, and a service version 713, which the service has implemented in relation to the service type 711.

Typically, service types 710 evolve over time and newer versions support a larger or otherwise improved feature set or one that is configured to the current state of the art. The naming of the versions supported by the service allows the communication subscriber to recognize whether the communication subscriber will understand a particular form of a request message 740.

Furthermore, the first message content 710 may include a subscriber identifier 712 that either uniquely identifies the service within the automation system or identifies a group of services that belong together and do not need to be differentiated. The subscriber identifier 712 may be used by the communication subscriber to decide with which services of a plurality of services of the same type the communication subscriber wants to interact. For example, a subscriber identifier 712 that designates a service may be an address. A subscriber identifier 712 that designates a group of services may, for example, be an indication of the service's affiliation with an organization.

The subscriber identifier 712 may alternatively be contained in the meta information 701 in the availability message 700 instead of in the message content 710, for example as part of the topic name 702.

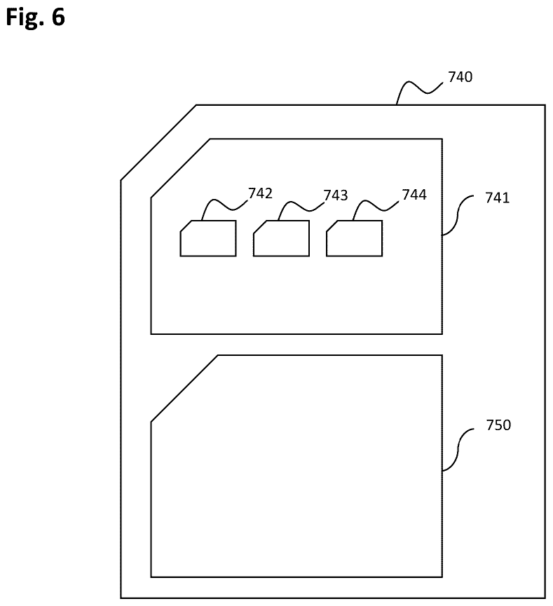

As FIG. 6 shows, a request message 740 of a communication subscriber is composed of second metadata 741 and of a second message content 750, analogous to an availability message 700. Components of the second metadata 741 are a first delivery route 742, optionally a second return route description 743 and also optionally first correlation data 744. The first delivery route 742 describes the route via which the request message 740 is to be transmitted to the desired service. The second return route description 743 for the request message 740 is only required if a response message 780 is expected from the service.

The first correlation data 744 is assigned to the request message 740 if the communication subscriber sends several request messages 740 to the same or different services without first waiting for the response messages 780. The service then copies the first correlation data 744 from the respective request message 740 into the response message 780 and the communication subscriber may use the first correlation data 744 after receiving the response message 780 to assign to which request message 740 the response message 780 belongs.

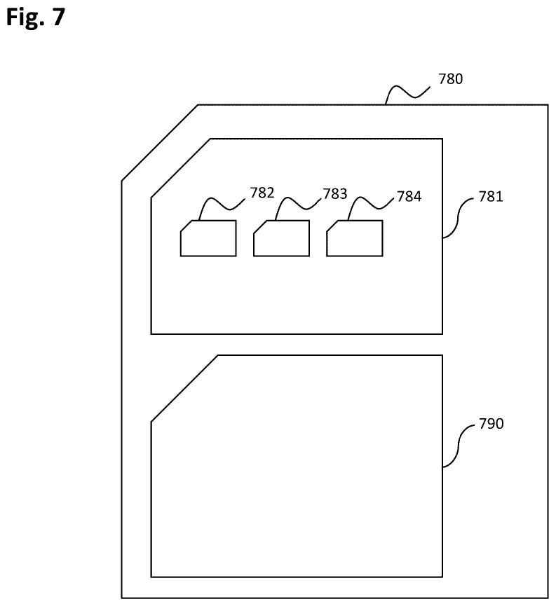

As shown in FIG. 7, similar to an availability message 700 or a request message 740, a response message 780 comprises third metadata 781 and a third message content 790. A second delivery route 782, optionally a third return route description 783 and also optionally second correlation data 784 are associated with the third metadata 781. The second delivery route 782 describes the transmission route via which the response message 780 of the service is to be transmitted to the communication subscriber that sent the associated request message 740.

For the value of the delivery route in the response message 780, the service uses the return route description from the request message 740. If the request message 740 contained first correlation data 744, the service repeats the second correlation data 784 in the response message 780 so that the requesting communication subscriber may assign the response message 780 to the request message 740. This is particularly advantageous if the service has reported itself in the availability message 700 without a unique subscriber identifier and the communication subscriber interacts with a plurality of services of the same service type 711.

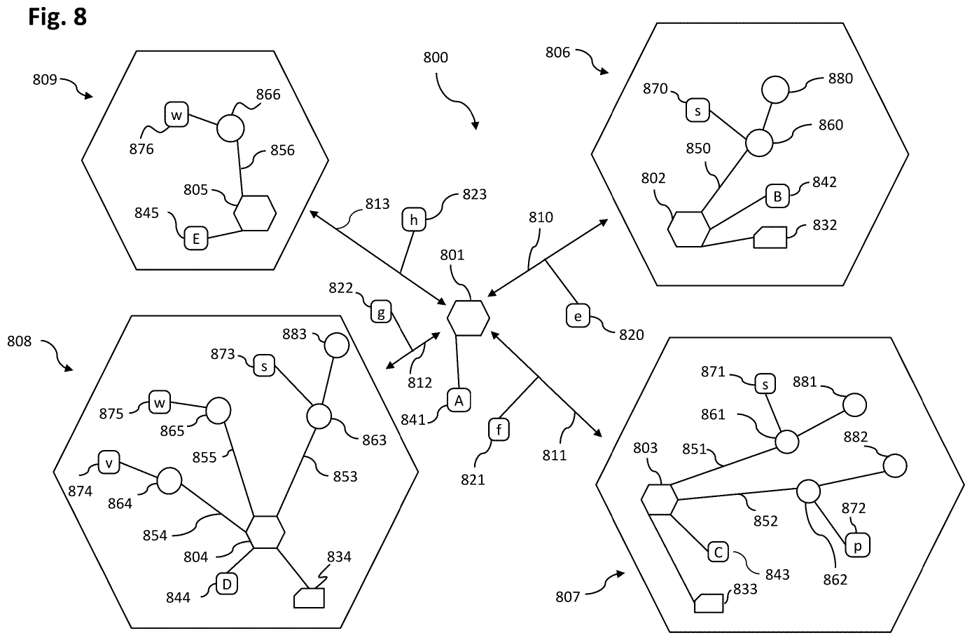

FIG. 8 schematically shows a possible structure of an automation system. The exemplary automation system 800 comprises four communication subscribers, a first communication subscriber 806, a second communication subscriber 807, a third communication subscriber 808 and a fourth communication subscriber 809. In principle, any number of communication subscribers may be provided in the automation system.

All communication subscribers in the automation system 800 are connected to a message broker 801 via an assigned switching bridge. That is, the first communication subscriber 806 is connected to the message broker 801 via a first switching bridge 810, the second communication subscriber 807 is connected to the message broker 801 via a second switching bridge 811, the third communication subscriber 808 is connected to the message broker 801 via a third switching bridge 812 and the fourth communication subscriber 809 is connected to the message broker 801 via a fourth switching bridge 813.

Instead of using a switching bridge, the communication subscribers may also be connected directly to the message broker via communication links. Networks of message brokers may also be used instead of a single message broker.

Furthermore, the automation system may also have extensions. For example, further system sections may be added that include communication subscribers, message brokers and switching bridges.

Each communication subscriber generally comprises a subscriber message broker which is connected to the associated switching bridge. That is, the first communication subscriber 806 is connected to the first switching bridge 810 via a first subscriber message broker 802, the second communication subscriber 807 is connected to the second switching bridge 811 via a second subscriber message broker 803, the third communication subscriber 808 is connected to the third switching bridge 812 via a third subscriber message broker 804, and the fourth communication subscriber 809 is connected to the fourth switching bridge 813 via a fourth subscriber message broker 805.

Each switching bridge may also be integrated into the assigned communication subscriber instead of being implemented separately from the assigned communication subscriber, as shown in FIG. 8. In this case, the switching bridge may be part of the subscriber message broker in the communication subscriber.

Each switching bridge is assigned a bridge designation that uniquely identifies the switching bridge in relation to the other switching bridges that are connected to the message broker 801. In an automation system 800, bridge designations must always be unique from one another if the switching bridges are connected to the same message broker or subscriber message broker.

In FIG. 8, the first switching bridge 810 has the letter “e” as the first bridge designation 820, the second switching bridge 811 has the letter “f” as the second bridge designation 821, the third switching bridge 812 has the letter “g” as the third bridge designation 822 and the fourth switching bridge 813 has the letter “h” as the fourth bridge designation 823.

Each message broker or subscriber message broker is assigned a broker designation, wherein, analogous to the bridge designations, different broker designations must be assigned to message brokers or subscriber message brokers if they are connected to one another via a switching bridge. For this reason, it is provided in the automation system 800 shown in FIG. 8 that all switch designations must be unique, since in the automation system 800 all subscriber message brokers contained in the communication subscribers are connected to the same message broker 801 via an assigned switching bridge.

In the automation system 800 shown in FIG. 8, the first subscriber message broker 802 has the letter “B” as the first broker designation 842, the second subscriber message broker 803 has the letter “C” as the second broker designation 843, the third subscriber message broker 804 has the letter “D” as the third broker designation 844, and the fourth subscriber message broker 805 has the letter “E” as the fourth broker designation 845.

The requirement that the bridge designations and switching designations only have to be unique within local boundaries ensures autonomy in the assignment of designations within local boundaries.

Each communication subscriber includes a subscriber identifier that is linked to the respective subscriber message broker and uniquely identifies the subscriber message broker.

In the automation system 800 shown in FIG. 8, the first communication subscriber 806 comprises a first subscriber identifier 832 for the first subscriber message broker 802, the second communication subscriber 807 comprises a second subscriber identifier 833 for the second subscriber message broker 803, the third communication subscriber 808 comprises a third subscriber identifier 834 for the third subscriber message broker 804, and the fourth communication subscriber 309 comprises a fourth subscriber identifier 835 for the fourth subscriber message broker 805.

In the following, a distinction is made between applications and services. In this context, applications are executed programs or procedures that cause a service to carry out an action, while services are executed programs or procedures that carry out actions on behalf of an application and may respond with a reaction, such as results. The same executed instance of a program may act both as a service and as an application. In principle, however, it is possible to dispense with a distinction between applications and services.

In order to allow for services to carry out actions, each service is assigned an object collection on which the service carries out actions. Objects of an object collection are, for example, variable values of a program, entries in a database or methods that may be executed. An object may also be implemented by the instance of a class of a higher programming language such as C++. In principle, objects may represent any real or virtual objects.

In an automation system 800, each communication subscriber may comprise any number of services and/or applications, each of which may communicate with the communication subscriber's subscriber message broker via a separate communication link to receive messages by subscribing to topic names 441 and/or topic filters 451 and to send messages by publishing to a particular topic.

The communication subscribers in the automation system 800 may each form a separate unit in the form of a physical device. However, the communication subscribers may also be composed of a plurality of devices that may communicate with one another via physical or wireless communication links. Services, applications and subscriber message brokers of a communication subscriber may, for example, be carried out on different devices. The services, applications and subscriber message brokers of a communication subscriber may also be jointly executed on the same device with services, applications and subscriber message brokers of another communication subscriber.

The switching bridges may also be embodied as a single device or form part of the device or device system of an assigned communication subscriber. Furthermore, the switching bridges may form a unit together with the message broker.

In the automation system 800 shown in FIG. 8, the first communication subscriber 806 comprises a first service 860 which is connected to the first subscriber message broker 802 via a first communication link 850. A first object collection 880 is associated with the first service 860.

The second communication subscriber 807 comprises a second service 861 which is connected to the second subscriber message broker 803 via a second communication link 851, and a third service 862 which is connected to the second subscriber message broker 803 via a third communication link 852. A second object collection 881 is associated with the second service 861 and a third object collection 882 is associated with the third service 862.

The third communication subscriber 808 comprises a fourth service 863, which is connected to the third subscriber message broker 804 via a fourth communication link 853. A fourth object collection 883 is associated with the fourth service 863. The third communication subscriber 808 further comprises a first application 864 connected to the third subscriber message broker 804 via a fifth communication link 854, and a second application 865 connected to the third subscriber message broker 804 via a sixth communication link 855.

The fourth communication subscriber 809 comprises a third application 866, which is connected to the fourth subscriber message broker 805 via a seventh communication link 856.

In the automation system 800, each service is assigned a service name and each application is assigned an application name. The service designations or application designations must be unique within the respective communication subscriber.

As shown in FIG. 8, in the first communication subscriber 806, the first service 860 has the letter “s” as the first service designation 870. The second service 861 of the second communication subscriber 807 also has the letter “s” as the second service designation 871. The third service 862 of the second communication subscriber 807 has the letter “p” as the third service designation 872.

In the third communication subscriber 808, the fourth service 863 again has the letter “s” as the fourth service designation 873. The first application 864 of the third communication subscriber 808 has the letter “v” as the first application designation 874 and the second application 865 of the third communication subscriber 808 has the letter “w” as the second application designation 875. In the fourth communication subscriber 809, the third application 866 again has the letter “w” as the third application designation 876.

The message brokers 801 or subscriber message brokers use topic trees 400 so that a request message 740 may be published for a topic name 441 or a response message 780 may be received via a subscription to a topic name 441 or a part of the topic tree 400 with a topic filter 451. In each case, the delivery route may be specified as part of the topic or, analogously, as part of the response topic 481. The route section designations of the delivery route then correspond to the topic elements in the topic levels of the topic or of the response topic 481. The part in the topic tree 400 which contains the route section designations is referred to as the route tree layer.

The delivery routes relate to the respective message broker 801 or subscriber message broker and therefore change from message broker or subscriber message broker to message broker 801 or subscriber message broker. As a consequence, the arrangement of the topic levels within a topic tree 400 for the delivery route changes from the perspective of the respective message broker 801 or subscriber message broker.

During operation, a message broker 801 or subscriber message broker does not necessarily need to know a complete topic tree 400 for the automation system 800. The message broker 801 or subscriber message broker then only has knowledge of the parts of the topic tree 400, which are made up of the topics of the published messages and the existing subscriptions.

The structure of topic trees 400 in which bridge designations are used to identify delivery routes is described below. As described above, other values from the automation system 800, such as broker designations, may also be used instead of bridge designations as route section designations.

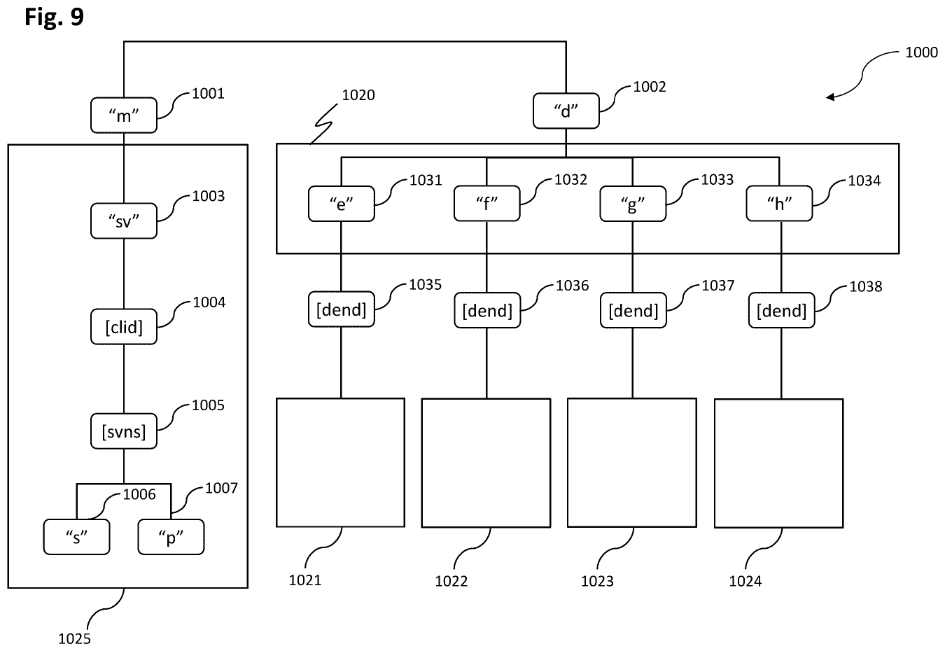

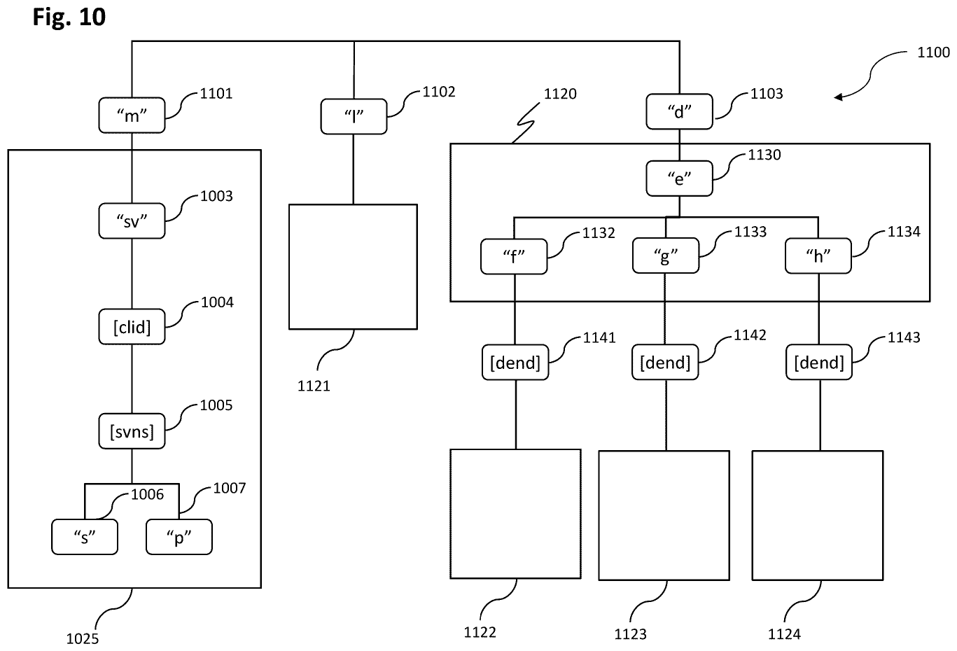

FIG. 9 shows a first topic tree 1000 from the point of view of the message broker 801 in the automation system 800 of FIG. 8. Furthermore, FIG. 10 shows a second topic tree 1100 from the point of view of the first subscriber message broker 802 in the first communication subscriber 806 of the automation system 800 of FIG. 8.

In the first topic tree 1000, a distinction is made between topics that contain a delivery route and those that contain no delivery route or, equivalently, an empty delivery route. The topic may then be used to determine whether a message is to be delivered locally to one or to a plurality of applications and/or services of a communication subscriber or must first be transported via route sections before delivery. Furthermore, topics for availability messages 700 are marked in the first topic tree 1000, as availability messages 700 are forwarded via all communication connections in order to reach all communication subscribers.

From the point of view of the message brokers 801 or subscriber message brokers, the roots of the topic tree are used to distinguish between the three types of topics mentioned above in the topic tree. The root with the letter “m” stands for “multicast” (“transmission to multiple recipients”) and describes all topics that are used in availability messages 700. The root with the letter “d” stands for “direction” and describes all topics for which the messages containing the topics have a delivery route. The root with the letter “l” stands for “local” and is assigned to all topics for which the messages containing the topics do not contain a delivery route and therefore do not have to be transported via route sections. Instead of using the roots of the topic tree to identify the three types of topics, other forms of identification may also be used.

In the first topic tree 1000 shown in FIG. 9 from the point of view of the message broker 801, a first root “m” 1001 is provided for “multicast” and a first root “d” 1002 for “direction”. A first root “l” for “local” is not required and therefore does not appear in the first topic tree 1000, since the message broker 801 does not have a direct communication link with any application or service.

In the second topic tree 1100 shown in FIG. 10 from the perspective of the first subscriber message broker 802 in the first communication subscriber 806, in addition to a second root “m” 1101 for “multicast” and a second root “d” 1103 for “direction”, a second root “l” 1102 for “local” is also included, since the first service 860 in the first communication subscriber 806 maintains the first communication connection 850 to the first subscriber message broker 802 in the first communication subscriber 806 and subscribes to topics below the root “1”.

Delivery routes are shown in the first topic tree 1000 and in the second topic tree 1100 below the first root “d” 1002 and below the second root “d” 1103, respectively. The subordinate topic levels following root “d” each contain route section designations as topic elements in the form of bridge designations, which form a route tree layer until a stop tree layer in the form of a further topic level marks the end of the delivery route in the topic tree with a predefined stop value, which does not stand for a route section designation.

In the automation system 800 shown in FIG. 8, the message broker 801 has the following route sections to further subscriber message brokers in the communication subscribers in the form of bridge connections. The message broker 801 is connected to the first subscriber message broker 802 in the first communication subscriber 806 via the first switching bridge 810 with the first bridge designation 820, which comprises the letter “e”. The message broker 801 is connected via the second switching bridge 811 with the second bridge designation 821, which comprises the letter “f”, to the second subscriber message broker 803 in the second communication subscriber 807. The message broker 801 is connected via the third switching bridge 812 with the third bridge designation 822, which comprises the letter “g”, to the third subscriber message broker 804 in the third communication subscriber 808. The message broker 801 is connected via the fourth switching bridge 813 with the fourth bridge designation 823, which comprises the letter “h”, to the fourth subscriber message broker 805 in the fourth communication subscriber 809.

In the first topic tree 1000 shown in FIG. 9 from the point of view of the message broker 801, the following route section designations in the form of bridge designations are therefore indicated under the first root “d” 1002 in a first route tree layer 1020 for delivery routes or return route descriptions as topic elements in a topic layer: First route topic element “e” 1031, second route topic element “f” 1032, third route topic element “g” 1033 and fourth route topic element “h” 1034.

Since the message broker 801 is always directly connected to the further subscriber message brokers, the one topic level in the first route tree layer 1020 in the first topic tree 1000 is not followed by a further topic level for delivery routes or return route descriptions. The end of the delivery routes or return route descriptions is therefore indicated in the first topic tree 1000 with a stop tree layer.

In the first topic tree 1000 shown in FIG. 9, first stop topic elements 1035, second stop topic elements 1036, third stop topic elements 1037 and fourth stop topic elements 1038 containing a placeholder “[dend]” are provided in the stop tree layer for each topic element of the topic level in the first route tree layer 1020. The placeholder “[dend]” is usually a predefined value. It is advantageous to use an empty value for these topic elements because an empty space as a route section designation is not common in real life either.

In the automation system 800 shown in FIG. 8, the first subscriber message broker 802 in the first communication subscriber 806 is connected via the first switching bridge 810 having the first bridge designation 820, which comprises the letter “e”, to the message broker 801, which in turn is then connected via the second switching bridge 811 having the second bridge designation 821, which comprises the letter “f”, to the second subscriber message broker 803 in the second communication subscriber 807, via the third switching bridge 812 having the third bridge designation 822, which comprises the letter “g”, establishes the connection with the third subscriber message broker 804 in the third communication subscriber 808 and via the fourth switching bridge 813 having the fourth bridge designation 823, which comprises the letter “h”, establishes the connection with the fourth subscriber message broker 805 in the fourth communication subscriber 809.

Since the first subscriber message broker 802 in the first communication subscriber 806 is always connected to the subscriber message brokers in the further communication subscribers via the message broker 801, the second topic tree 1100 shown in FIG. 10 therefore comprises a second route tree layer 1120 for delivery routes or return route descriptions with two topic levels under the second root “d” 1103. In a first topic level of the second route tree layer 1120, the fifth route topic element “e” 1130 is specified as a route section designation in the form of a bridge designation, which represents the direct connection from the first subscriber message broker 802 to the message broker 801. In a second topic level of the second route tree layer 1120, the connections from the message broker 801 to the subscriber message brokers in the other communication subscribers are then defined via the following route section designations in the form of bridge designations: sixth route topic element “f” 1131, seventh route topic element “g” 1132 and eighth route topic element “h” 1133.

The end of the delivery routes or the return route descriptions is then indicated in the second topic tree 1100, as FIG. 10 shows, with a stop tree layer, which comprises a fifth stop topic element 1141, a sixth stop topic element 1142 and a seventh stop topic element 1143 for the topic elements of the second topic level in the second route tree layer 1120, which contain the placeholder “[dend]”.

When transmitting messages between the message brokers 801 via the switching bridges, the topics in the messages are modified so that the route section designations for the delivery route are removed from the topic. All applications and services of the communication subscriber therefore subscribe to topics with constant roots without a route tree layer in the first topic tree 1000 of the message broker 801 of the communication subscriber.

The topics for subscriptions by applications and services of a communication subscriber with a communication connection to the subscriber message broker of the communication subscriber are described by a topic tree section below the root “l”. In the example of the second topic tree 1100 in FIG. 10, a first topic tree section 1125 is arranged below the second root “l” 1102 with all topic levels for topics of the first service 860 with the first communication connection 850 to the first subscriber message broker 802 in the first communication subscriber 806.

Under the second root “m” 1101 and the second root “l” 1102 or under the stop tree layer to mark the end of the delivery route at the second root “d” 1103 are the topic tree sections with the other topic levels that are required to form the topics.

The topic tree sections for availability messages 700, which indicate under the second root “m” 1101 which services are provided by the communication subscribers and under which topics the communication subscribers expect request messages 740, are identical in all topic trees that are assigned to the message brokers 801 in the automation system 800 shown in FIG. 8. A first topic tree section 1025 is therefore provided under the first root “m” 1001 and the second root “m” 1101 in the first topic tree 1000 from the point of view of the message broker 801 or in the second topic tree 1100 first subscriber message broker 802 in the first communication subscriber 806.

As only the topic levels of the topic trees that relate to the delivery route or the return route description, i.e. the route tree layer, are changed during message transmission, the further topic tree sections are also identical in all topic trees that are assigned to the message brokers 801 in the automation system 800 shown in FIG. 8.

The topic tree sections with the topic levels to be subscribed to by the applications and services in the automation system 800 are located under the stop tree layer for marking the end of the delivery route. In the case of the message brokers 801, which have a direct communication link with the services or applications, the topic tree section is then arranged under the second root “l” 1102, since the topic tree section has reached the respective destination, which is described via the delivery route.

In the first topic tree 1000 shown in FIG. 9 from the perspective of the message broker 801, below the first root “d” 1002, separated by the first route tree layer 1020 and the subsequent stop tree layer, are a second topic tree section 1021 for the first subscriber message broker 802, a third topic tree section 1022 for the second subscriber message broker 803, a fourth topic tree section 1023 for the third subscriber message broker 804 and a fifth topic tree section 1024 for the fourth subscriber message broker 805.

In the second topic tree 1100 shown in FIG. 10 as seen by the first subscriber message broker 802, the seventh topic tree section 1122 for the second subscriber message broker 803, the eighth topic tree section 1123 for the third subscriber message broker 804, and the ninth topic tree section 1124 for the fourth subscriber message broker 805 are arranged under the second root “d” 1103, separated by the second route tree layer 1120 and the subsequent stop tree layer. The sixth topic tree section 1121, which contains the topics for the services and applications connected to the first subscriber message broker 802 in the first communication subscriber 806 via the first communication link 850, is then located under the second root “l” 1102.

In the first topic tree 1000 from the viewpoint of the message broker 801, the topics with a delivery route have the following form, wherein the placeholder 471 “#” represents any number of further topic levels:
“d/e//#” for the delivery route to the first subscriber message broker 802 in the first communication subscriber 806,
“d/f//#” for the delivery route to the second subscriber message broker 803 in the second communication subscriber 807,
“d/g//#” for the delivery route to the third subscriber message broker 804 in the third communication subscriber 808 and
“d/h//#” for the delivery route to the fourth subscriber message broker 805 in the fourth communication subscriber 809.

In the second topic tree 1100 from the viewpoint of the first subscriber message broker 802 in the first communication subscriber 806, the topics with a delivery route have the following form, where the placeholder 471 “#” represents any number of further topic levels:
“d/e/f//#” for the delivery route to the second subscriber message broker 803 in the second communication subscriber 807,
“d/e/g//#” for the delivery route to the third subscriber message broker 804 in the third communication subscriber 808 and
“d/e/h//#” for the delivery route to the fourth subscriber message broker 805 in the fourth communication subscriber 809.

In principle, a variety of options for the structure of topic tree sections under the roots or under the route-tree layers in the topic tree is provided. FIGS. 9 and 10 show an advantageous configuration, particularly with regard to the arrangement and number of topic levels. However, the arrangement of the topic levels shown may be varied. The order of the topic levels may also be reversed. Furthermore, individual topic levels may be omitted.

The structure of the first topic tree section 1025 for availability messages 700, which is arranged in the first topic tree 1000 or in the second topic tree 1100 under the first root “m” 1001 and the second root “m” 1101, is described below. The structure may be used analogously for the further topic tree sections in the first topic tree 1000 o, respectively, in the second topic tree 1100.

A first topic level is arranged under the root “m” in the topic tree in the first topic tree section 1025 with a fifteenth topic element “sv” 1003. The value “sv” in the fifteenth topic element 1003 stands for “service” and indicates that the subsequent topic levels relate to services. The first topic level is used to identify the type of availability message 700 in order to be able to distinguish between several types of availability messages 700 as the case may be.

A further type of availability message 700 could, for example, be availability messages 700 that are published by applications and not by services. The further type of availability messages 700 could then in turn be displayed by further topic element in the first topic level, which is then assigned a different constant value.

However, the differentiation between the types of availability messages 700 does not have to be taken via a topic level, but may also be indicated by the message content of the availability message 700. By differentiating with the aid of a topic level, however, applications have the option, particularly when using the “MQTT version 5.0” standard, of continuing to receive only availability messages 700 from services by subscribing to topics below the fifteenth topic element “sv” 1003, even if an extended procedure with additional availability message types is used.

The second topic level following the first topic level in the first topic tree section 1025 comprises a sixteenth topic element “[clid]” 1004. However, a plurality of topic elements may be arranged on the second topic level. The value “[clid]” represents a placeholder 471 that may correspond, for example, to a subscriber identifier associated with a communication subscriber in the automation system 800 shown in FIG. 8 to identify the associated message broker or subscriber message broker.

If the subscriber identifier is a so-called fully qualified computer name including an Internet domain value such as “ipc4711.example.com”, the fully qualified computer name—in the example “ipc4711.example.com”—may be inserted into the sixteenth topic element “[clid]” 1004 as the value for the placeholder 471 “[clid]”.

Instead of a single second topic level, the second topic level may also be divided into several consecutive topic levels. For the fully qualified computer name “ipc4711.example.com” for a subscriber identifier, three topic elements in three consecutive second topic levels may also be used as an alternative to the representation in one topic element in a second topic level, wherein the three topic elements then have the values “com”, “example”, “ipc4711” in this order.

With the second topic level, applications may subscribe to availability messages 700 for specific subscriber identifiers if they are interested in the services that maintain direct communication links with message brokers 801 to which matching subscriber identifiers are assigned. The subscriber identifier may be inserted into the availability message 700 before, during or after the sending of an availability message 700 by the service itself, the subscriber message broker in the communication subscriber or the switching bridge connected to the communication subscriber in the topic of the availability message 700 as a single second topic level or a sequence of second topic levels.

However, the subscriber identifier does not have to be displayed in the availability message 700 in the form of a topic level, but may also be represented by the message content of the availability message 700, as shown in FIG. 5.

A third topic level, which follows the second topic level in the first topic tree section 1025, comprises a seventeenth topic element “[svns]” 1005. However, a large number of topic elements may be arranged on the third topic level. The placeholder 471 “[svns]” in the seventeenth topic element “[svns]” 1005 stands for “service namespace” and allows the same value for a service name to be used for different services, even if these services are directly connected to a communication link with the same subscriber message broker or message broker 801.

Each communication subscriber may be assigned a value for the placeholder 471 “[svns]” that uniquely identifies the communication subscriber. The communication subscribers may then autonomously and without mutual coordination assign service names to the services of the communication subscriber, which may also be identical. The applications may distinguish the services of the different communication subscribers by the value for the placeholder 471 “[svns]” in the topic elements of the third topic level.

The provision of the third topic level in the first topic tree section 1025 is particularly advantageous if services are provided in so-called containers, i.e. executable units, and are executed by the operator of a communication subscriber in an execution environment for container instances within the communication subscriber. This is because the operator of the communication subscriber is generally limited in the options with regard to the value for the service names of the services within the containers used by the operator.

The eighteenth topic element “s” 1006 and the nineteenth topic element “p” 1007 of the fourth topic level, which follows the third topic level in the first topic tree section 1025, each indicate a service designation. In the automation system 800 shown in FIG. 8, only the values “s” and “p” are used for the service designations. The service designation stands for a service type 711 such as a database, a file system or a programmable controller and is not unique within the automation system 800, as already described.

For example, if the value of the first subscriber identifier 832 for the first subscriber message broker 802 in the first communication subscriber 806 is “ipc4711.example.com” and for the sixteenth topic element “[clid]” 1004 is used instead of the second topic level in the first topic tree section 1025 divided up into a plurality of topic elements in successive topic levels, the topic of an availability message 700 for the first service 860, which has the letter “s” as the first service identifier 870, formulated according to the standard “MQTT version 5.0”, may be “m/sv/com/example/ipc4711/dm/s”. For the placeholder 471 “[svns]” in the seventeenth topic element “[svns]” 1005 of the third topic level, the value “dm” is used, which stands for “device management”. An advantage of such a configuration of the topics for availability messages 700 is that applications may easily subscribe to the availability messages 700 of groups of services of an Internet domain, for example with the topic filter “m/sv/com/example/#”.

If the first subscriber identifier 832 is represented in a single topic level with the value “ipc4711.example.com”, the topic for an availability message 700 is “m/sv/ipc4711.example.com/dm/s”. With availability messages 700 embodied in this manner, applications may simply subscribe to the availability messages 700 of services of a specific service namespace in the automation system 800, for example with the topic filter 451 “m/sv/+/dm/+”.

The switching bridges of the automation system 800 use lists of subscriptions and translation tables. The subscriptions allow the switching bridges to subscribe to topics at the message brokers associated with the switching bridges to be forwarded by the switching bridges. The translation tables allow the switching bridges to change the topic or reply topic 481 before, during or after transmission as the case may be.

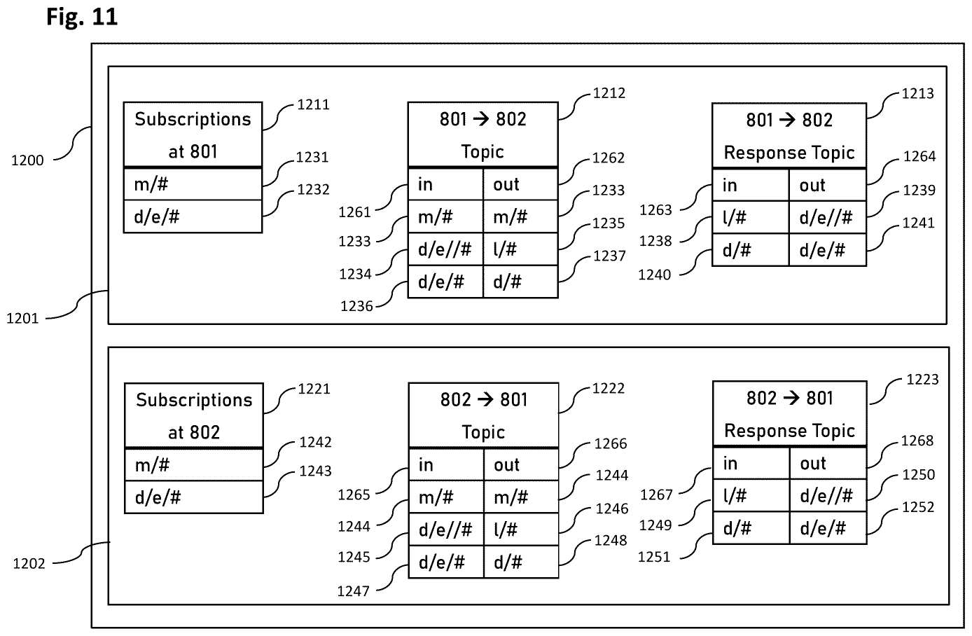

FIG. 11 shows an example of a first group 1200 of two sets, each with a subscription list and two translation tables for the first switching bridge 810 in the automation system 800, which has the first bridge designation “e” 820.

A first set 1201 comprises a first subscription list 1211 and a first translation table 1212 and a second translation table 1213. The first subscription list 1211 includes topic filters that the first switching bridge 810 subscribes to the message broker 801. The first translation table 1212 includes translation rules for topics of messages received by the first switching bridge 810 from the message broker 801 for forwarding to the first subscriber message broker 802 using the subscriptions of the first subscription list 1211.

The second translation table 1213 includes translation rules for response topics 481 of messages received using the subscriptions of the first subscription list 1211 by the first switching bridge 810 from the message broker 801 for forwarding to the first subscriber message broker 802.

Similarly, a second set 1202 comprises a second subscription list 1221 as well as a third translation table 1222 and a fourth translation table 1223. The second subscription list 1221 comprises topic filters to which the first switching bridge 810 subscribes at the first subscriber message broker 802.

The third translation table 1222 includes translation rules for topics of messages received using the subscriptions of the second subscriber list 1221 by the first switching bridge 810 from the first subscriber message broker 802 for forwarding to the message broker 801.

The fourth translation table 1223 includes translation rules for response topics 482 of messages received using the subscriptions of the second subscription list 1223 by the first switching bridge 810 from the first subscriber message broker 802 for forwarding to the message broker 801.

The first subscription list 1211 comprises a first line with a first topic filter “m/#” 1231 and a second line with a second topic filter “d/e/#” 1232. The first topic filter “m/#” 1231 causes the first switching bridge 810 to forward all availability messages 700 that are published at the message broker 801. The second topic filter “d/e/#” 1232 causes all request messages 740 and response messages 780 to be received by the first switching bridge 810, which are published at the message broker 801 and are to be forwarded via the first switching bridge 810.

The first translation table 1212 includes a first row with a third topic filter “m/#” 1233 on both the first input side “in” 1261 and the first output side “out” 1262, which causes the topic of availability messages 700 to be forwarded unchanged from the first switching bridge 810 to the first subscriber message broker 802.

The first translation table 1212 further comprises a second line with a fourth topic filter “d/e//#” on the first input side “in” 1261 and a fifth topic filter “l/#” on the first output side “out” 1262. The rule of the second line of the first translation table 1212 causes the first switching bridge 810 to remove the delivery route from the topic of messages when forwarding from the message broker 801 to the first subscriber message broker 802, and replace it with the second root “l” 1102. The second root “l” 1102 thereby indicates services or applications that have subscribed to the topic, have a direct communication link to the subscriber message broker, which is given for the first service 860 in the first communication subscriber 860 with respect to the first subscriber message broker 802.

Further, the first translation table 1212 comprises a third line with a sixth topic filter “d/e/#” 1236 on the first input side “in” and a seventh topic filter “d/#” 1237 on the first output side “out” 1262. The rule of the third line of the first translation table 1212 has the effect that delivery routes in the topic of messages are reduced by the bridge designation “e” 820 of the first switching bridge 810 from that of the first switching bridge 810 during forwarding from the message broker 801 to the first subscriber message broker 802, which would not yet have reached their destination when published in the first subscriber message broker 802 and still have to be forwarded via at least one route section. This is superfluous for the first communication subscriber 806 because it only has a switching bridge.

The second translation table 1213 comprises a first line with an eighth topic filter “l/#” 1238 on the second input side “in” 1263 and a ninth topic filter “d/e//#” 1239 on the second output side “out” 1264. With the first line, the response topic 481 of messages receives a delivery route if published at the message broker 801 by a service or application directly connected to it. In the automation system 800, no services or applications are directly connected to the message broker 801, which is why the rule is not required.

The second translation table 1213 further comprises a second line with a tenth topic filter “d/#” 1240 on the second input side “in” 1263 and an eleventh topic filter “d/e/#” 1241 on the second output side “out” 1264. The rule of the second line of the second translation table 1213 causes the delivery route in the response topic 481 of messages to be extended by the bridge designation “e” 820. In the automation system 800, the first switching bridge 810 thus supplements the response topic 481 of messages when forwarding from the message broker 801 to the first subscriber message broker 802.

The first set 1201 and second set 1202 with subscription lists and translation tables shown in FIG. 11 represent the two transmission directions of messages through the first switching bridge 810 in the automation system 800. The first set 1201 represents message forwarding from the message broker 801 to the first subscriber message broker 802 via the first switching bridge 810. The second set 1202 then applies to the reverse direction of message forwarding from the first subscriber message broker 802 to the message broker 801 via the first switching bridge 810.

The second subscription list 1221, the third translation table 1222 and the fourth translation table 1223 of the second set 1202 and the first subscription list 1211, the first translation table 1212 and the second translation table 1213 of the first set 1201 comprise an identical content. However, there is a difference when used in the automation system 800.

Like the first subscription list 1221 indicating the subscriptions of the first switching bridge 810 at the first subscriber message broker 802, the second subscription list 1221 indicating the subscriptions of the first switching bridge 810 at the message broker 801 includes a first line with a twelfth topic filter “m/#” 1242 and a second line with a thirteenth topic filter “d/e/#” 1243.

The third translation table 1222 comprises a first line with a fourteenth topic filter “m/#” 1244 on both the third input side “in” 1265 and the third output side “out” 1266, which causes the topic of availability messages 700 to be forwarded unchanged from the first switching bridge 810 to the message broker 801.

The third translation table 1222 further comprises a second line with a fifteenth topic filter “d/e//#” 1245 on the third input side “in” 1265 and a sixteenth topic filter “l/#” 1246 on the third output side “out” 1266. The rule of the second line of the third translation table 1222 is not required in the automation system 800, in contrast to the rule of the second line of the first translation table 1212, since no services or applications are directly connected to the message broker 801 which would use the second root “l” 1102 for the topics of their messages and their subscriptions there.

Further, the third translation table 1222 comprises a third line with a seventeenth topic filter “d/e/#” 1247 on the third input side “in” 1265 and an eighteenth topic filter “d/#” 1248 on the third output side “out” 1266. The rule of the third line of the third translation table 1222 is used to cause delivery routes in the topic of messages to be reduced by the first bridge designation “e” 820 of the first switching bridge 810 from the first switching bridge 810 when forwarding from the first subscriber message broker 802 to the message broker 801.

The fourth translation table 1223 includes a first row having a nineteenth topic filter “l/#” 1249 at the fourth input side “in” 1267 and a twentieth topic filter “d/e//#” 1250 at the fourth output side “out” 1268. The rule of the first row of the fourth translation table 1223 causes the reply topic 481 of messages to receive a delivery route when published to the first subscriber message broker 802 by the directly connected service 860. The rule causes the first switching bridge 810 to change the second root “l” 1102 to the second root “d” 1103 to indicate that the reply topic of messages receives a delivery route, additionally entering the first bridge label “e” 820 and the end of the return route description with an empty route section label. The rule of the first line of the third translation table 1222 is thus used by automation system 800 in contrast to the rule of the first line of the second translation table 1213, for example for availability messages as well as response messages.

The fourth translation table 1223 further comprises a second line with a twenty-first topic filter “d/#” 1251 on the fourth input side “in” 1267 and a twenty-second topic filter “d/e/#” 1252 on the output side “out” 1268. The rule of the second line of the fourth translation table 1223, which causes the delivery route in the response topic 481 of messages to be extended by the first bridge identifier “e” 820, is not required in the automation system 800, unlike the rule of the second line of the second translation table 1213, because the response messages 780 published by services in the first subscriber message broker 802 do not include a delivery route in the response topic 481.

All groups of two records, each with a subscription list and two translation tables, which are assigned to a switching bridge in the automation system 800, have the same structure as described in FIG. 11 for the first switching bridge 810. As far as the content is concerned, however, the bridge designation assigned to the corresponding switching bridge is entered instead of the first bridge designation “e” of the first switching bridge 810.

The records with subscription lists and translation tables therefore do not need to be preconfigured for the individual switching bridges. The switching bridge may generate the subscription lists and translation tables independently by inserting the bridge name. To configure a switching bridge, it is only necessary to specify between which two message brokers the switching bridge forms a communication link and which bridge designation is assigned to the switching bridge.

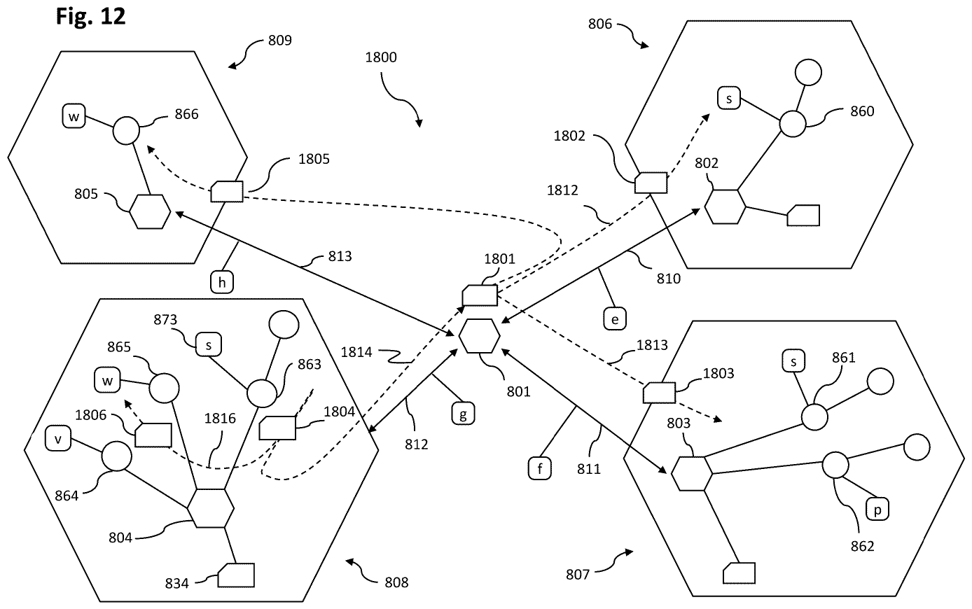

FIG. 12 shows the process in the automation system 800 of FIG. 8 when a fourth service availability message 1804 is published in the third communication subscriber 808 by the fourth service 863 at the third subscriber message broker 804 directly connected to the service. The fourth service availability message 1804 is structured according to the availability message 700 shown in FIG. 5 and has the optional unique value 704.

The third subscriber message broker 804 delivers an unmodified first message copy 1806 of the fourth service availability message 1804 to the first application 864 and second applications 865 directly connected to the third subscriber message broker 804, if they have established corresponding subscriptions.

A second message copy 1801 of the fourth service availability message 1804 is forwarded by the third subscriber message broker 804 via the third switching bridge 812 to the message broker 801 of the automation system 800, wherein the topic and response topic 481 in the second message copy 1801 of the fourth service availability message 1804 are processed according to the translation tables of the third switching bridge 812. In this process, the response topic 481 receives a return route description that includes the route section designation of the third switching bridge 812. The topic, on the other hand, remains unchanged. The third switching bridge 812 continues to store the unique value 704 from the second message copy 1801.

Based on the second message copy 1801, the message broker 801 then transmits a third message copy 1802 of the fourth service availability message 1804 to the first subscriber message broker 802 via the first switching bridge 810, a fourth message copy 1803 of the fourth service availability message 1804 via the second switching bridge 811 to the second subscriber message broker 803, and a fifth message copy 1805 of the fourth service availability message 1804 via the fourth switching bridge 813 to the fourth subscriber message broker 805.

When the respective message copy is delivered to the subscriber message broker, the switching bridge processes the topic or the response topic 481 according to the assigned translation table, wherein the return route description in the response topic 481 is extended by the route section designation of the respective switching bridge, while the topic remains unchanged. The switching bridge also saves the unique value 704 from the message copy.

In contrast, the third switching bridge 812 ignores the subscription to availability message 700 from the message broker 801 because the third switching bridge 812 already knows the unique value 704 from the second message copy 1801.

The third message copy 1802, fourth message copy 1803 and fifth message copy 1805, as well, are fed back to the assigned switching bridges by first subscriber message distributors 802, second subscriber message distributors 803 and fourth subscriber message distributors 805, because the switching bridges have each set up a subscription to availability message 700 with the subscriber message distributors. However, the switching bridges do not transmit the message copies further to the message broker 801, since the unique value 704 from the third message copy 1802, fourth message copy 1803 and fifth message copy 1805 is already known to the switching bridges.

Feedback due to repeated and multiplied transmission of message copies is thus prevented because the use of the unique value 704 in the availability message 700 allows for the detection of message copies that have already been transmitted.

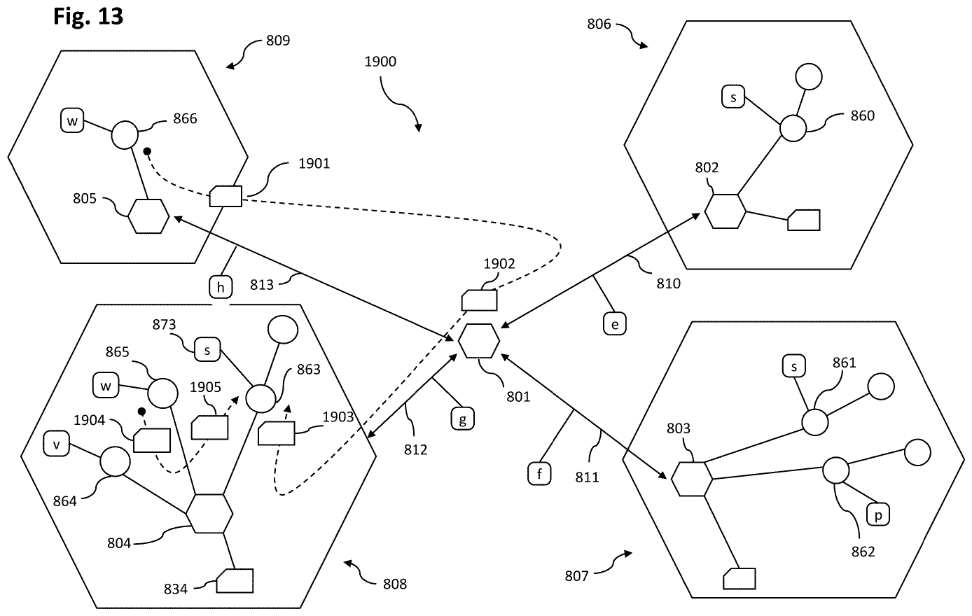

FIG. 13 shows the process in the automation system 800 of FIG. 8, in which both the first application 864 in the third communication subscriber 808 responds with a first application request message 1904 to the delivery of the fifth message copy 1805 of the fourth service availability message 1804 from the fourth service 863 in the third communication subscriber 808 and the third application 866 in the fourth communication subscriber 809 responds with a third application request message 1901 to the delivery of the fifth message copy 1805 of the fourth service availability message 1804 from the fourth service 863 in the third communication subscriber 808. However, there is generally no need to respond to availability messages.

The first-application request message 1904 and the third-application request message 1901 are structured according to the request message 740 shown in FIG. 6.

The first application 864 and the third application 866 use the response topic 481 of the fifth message copy 1805 or of the first message copy 1806, respectively, as the topic in the first application request message 1901 and the third application request message 1904, respectively. The return route description of the response topic 481 serves as the delivery route in the topic.

The first application 864 publishes the first application request message 1904 to the directly connected third subscriber message broker 804 in the third communication subscriber 808. Further, the third application 866 publishes the third application request message 1901 to the directly connected fourth subscriber message broker 805 in the fourth communication subscriber 809.

The third subscriber message broker 804 then transmits the first application request message 1904 to the fourth service 863 as an unmodified first message copy 1905, since the first application 864 and the fourth service 863 are directly connected to the third subscriber message broker 804 as part of the third communication subscriber 808.

However, the third switching bridge 812 connected to the third subscriber message broker 804 does not forward the first application request message 1904 because the third switching bridge 812 has not subscribed to a topic filter 451 at the third subscriber message broker 804 that matches the topic of the first application request message 1904.

The fourth subscriber message broker 805 in the fourth communication subscriber 809 transmits a sixth message copy 1902 of the third application request message 1901 to the message broker 801 via the fourth switching bridge 813, since the third switching bridge 812 has subscribed to a topic filter 451 matching the topic of the fourth application request message 1904 at the third subscriber message broker 804. In this case, the value of the delivery route in the topic of the sixth message copy 1902 of the third application request message 1901 is reduced by the route section designation of the fourth switching bridge 813 during transmission to the message broker 801.

In contrast to an availability message 700, the sixth message copy 1902 of the third application request message 1901 is forwarded by the central subscriber message broker 801 only via the third switching bridge 812, since the other switching bridges have not subscribed to any topic filters 451 at the message broker 801 that match the delivery route in the topic of the sixth message copy 1902 of the third application request message 1901.

The third switching bridge 812 then transmits a seventh message copy 1903 of the third application request message 1901 to the third subscriber message broker 804 in the third communication subscriber 806. The value of the delivery route in the topic of the seventh message copy 1903 of the third application request message 1901 is reduced by the route section designation of the third switching bridge 812 during transmission to the third subscriber message broker 804 and, since the third application request message 1901 has reached the third subscriber message broker 804, which is directly connected to the fourth service 863 in the third communication subscriber 808, is then empty or no longer provided.

The third subscriber message broker 804 then forwards the seventh message copy 1903 to the fourth service 863 directly connected to the third communication subscriber 806.

The above description shows that feedback for request messages 740 is avoided by multiple transmission of request messages 740. The delivery route in the topic of the request message 740 uses the different subscriptions of the switching bridges to ensure forwarding along exactly one route.

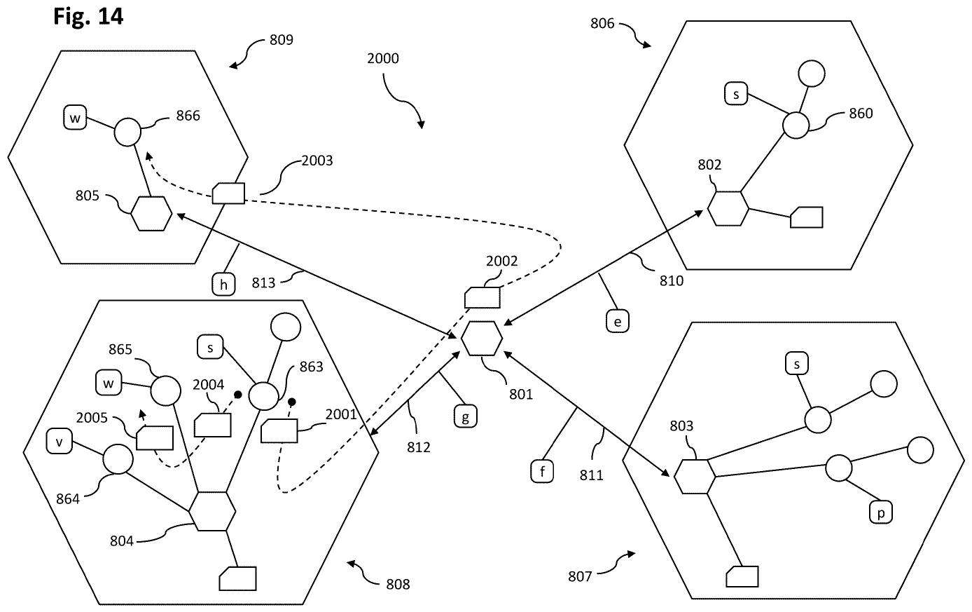

FIG. 14 shows, in the automation system 800 of FIG. 8, the procedure when the fourth service 863 in the third communication subscriber 808 responds to the delivery of the eighth message copy 1905 of the first application request message 1904 of the first application 864 in the third communication subscriber 808 with a first fourth service response message 2004 and responds to the delivery of the seventh message copy 1903 of the third application request message 1901 of the third application 866 in the fourth communication subscriber 809 with a second fourth service response message 2001.

The first fourth service response message 2004 and the second fourth service response message 2001 are structured according to the response message 780 shown in FIG. 7.

When a response message 780 is generated and published by a service, the response topic 481 in the response message 780 is changed in the response message 780 analogous to the availability message 700 when it is delivered to the application in the respective transmitted message copy of switching bridges according to the respective translation table assigned to it, if it is contained in the response message 780, and thus the return route description is recorded, which may be used by the application as a new value for further request messages 740.

The fourth service 863, when sending a response message 780, uses the response topic 481 of the eighth message copy 1905 of the first application request message 1904 as the topic for the first fourth service response message 2004 and the response topic 481 of the seventh message copy 1903 of the third application request message 1901 as the topic for the second fourth service response message 2001.

The request message 740 may also contain correlation data. The service then copies the correlation data from the respective request message 740 into the response message 780 and the communication subscriber can, after receiving the response message 780, assign to which request message 740 the response message 780 belongs.

As FIG. 14 shows, the fourth service 863 in the third communication subscriber 808 publishes the first fourth service response message 2004 to the third subscriber message broker 804 directly connected to the service. The third subscriber message broker 804 then delivers an unmodified ninth message copy 2005 of the first fourth service response message 2004 to the first application 864 directly connected to the third subscriber message broker 804 in accordance with a corresponding subscription of the first application 864 at the third subscriber message broker 804.

However, the third switching bridge 812 connected to the third subscriber message broker 804 does not forward the first fourth service response message 2004 as the third switching bridge 812 has not subscribed to a topic filter 451 at the third subscriber message broker 804 that matches the topic of the first fourth service response message 2004.

As FIG. 14 further shows, the fourth service 863 in the third communication subscriber 808 also publishes the second fourth service response message 2004 to the third subscriber message broker 804 directly connected to the service. However, since there is no matching subscription of the first applications 864 or the second applications 865 in the topic tree of the third subscriber message broker 804, the third subscriber message broker 804 then does not deliver message copies of the first fourth service response message 2004 to the applications directly connected to the third subscriber message broker 804.

However, the third subscriber message broker 804 transmits a tenth message copy 2002 of the second fourth service response message 2001 to the message broker 801 via the third switching bridge 812, since the third switching bridge 812 has subscribed to a topic filter 451 matching the topic of the second fourth service response message 2001 at the third subscriber message broker 804. In this case, the value of the delivery route in the topic of the tenth message copy 2002 of the second fourth service response message 2001 is reduced by the route section designation of the third switching bridge 812 during transmission to the message broker 801.

The message broker 801 then outputs the tenth message copy 2002 of the second fourth service response message 2001 to the fourth switching bridge 813, since the fourth switching bridge 813 has subscribed to the delivery route in the topic of the tenth message copy 2002 of the second fourth service response message 2001 at the message broker 801. No message copies of the second fourth service response message 2001 are forwarded via the other switching bridges connected to the message broker 801, since there is no corresponding subscription to the delivery route in the topic.

The value of the delivery route in the topic of a seventh message copy 1903 of the second fourth service response message 2001 is reduced by the route section designation of the fourth switching bridge 813 during transmission to the fourth subscriber message broker 805 and, since the second fourth service response message 2001 has reached the fourth subscriber message broker 805, which is directly connected to the addressee of the second fourth service response message 2001, the third application 866 in the fourth communication subscriber 809, is then empty or no longer present. The fourth subscriber message broker 805 then delivers the eleventh message copy 2003 of the second fourth service response message 2001 to the third application 866 in the fourth communication subscriber 809.

The above description again shows that feedback due to multiple transmissions is also avoided for response messages 780. The delivery route in the topic of the response message 740 uses the different subscriptions of the switching bridges to ensure forwarding along exactly one route.

As far as the procedure described with reference to FIGS. 12 to 14 is concerned, it makes no difference whether switching designations or bridge designations are used as route section designations in the topics or response topics 481 of availability messages 700, request messages 740 and response messages 780.

If the automation system 800 shown in FIG. 8 is extended by a new system section that includes additional communication subscribers with services and applications, subscriber message brokers and switching bridges, new topic tree sections are added to the topic trees that are created by the new route options. Only the added parts of the automation system require a new configuration, as well as the subscriber message broker or message broker to which the new system section is connected via a new switching bridge. All other parts of the automation system remain unchanged. Added parts do not have to be connected to the message broker 801, they may be connected to any subscriber message broker of the existing automation system 800 through a further switching bridge. It is even possible for a communication subscriber to take over the task of the message broker 801 with its subscriber message broker, i.e. services and applications with a direct communication link may also be connected to the message broker 801.

The formation rules for the topic trees, subscription lists and translation tables described above have the effect of automatically creating a forwarding to the message broker or subscriber message broker to which the new system section is connected, because availability messages 700 of services of the new system section are published via all message brokers 801 and thus further return route descriptions and delivery routes become valid.

In principle, however, it is also possible to selectively or generally suppress the forwarding of availability messages 700 or messages between old and new parts of the automation system 800 in the switching bridges that are connected to the message broker to which the new system section is connected via a new switching bridge.

In automation systems 800 with a network of message brokers 801, overlapping topic trees are formed because availability messages 700 or messages may be transmitted in different ways. The delivery routes may then be implicitly adapted if the topology changes or if the connection is overloaded.

TABLE 1
References 341-790

341 message
400 topic tree
410 fourth topic element
411 sixth topic element
412 ninth topic element
413 tenth topic element
415 seventh topic element
420 fifth topic element
430 first topic element
431 eighth topic element
432 eleventh topic element
433 twelfth topic element
435 second topic element
436 thirteenth topic element
437 fourteenth topic element
438 third topic element
441 topic name
451 topic filter
461 first level separator
462 second level separator
463 third level separator
464 fourth level separator
465 fifth level separator
471 placeholder
481 response topic
482 order topic
491 correlation information
700 availability message
701 first metadata
702 first topic name
704 unique value
710 first message content
711 service type
712 subscriber identifier
713 service version
720 first return route description
721 first route section designation
722 second route section designation
723 third route section designation
724 fourth route section designation
725 fifth route section designation
730 second return route description
740 request message
741 second metadata
742 first delivery route
743 second return route description
744 first correlation data
750 second message content
780 response message
781 third metadata
782 second delivery route
783 third return route description
784 second correlation data
790 third message content

TABLE 2
References 800-883

800 automation system
801 message broker
802 first subscriber message broker
803 second subscriber message broker
804 third subscriber message broker
805 fourth subscriber message broker
806 first communication subscriber
807 second communication subscriber
808 third communication subscriber
809 fourth communication subscriber
810 first switching bridge
811 second switching bridge
812 third switching bridge
813 fourth switching bridge
820 first bridge designation e
821 second bridge designation f
822 third bridge designation g
823 fourth bridge designation h
832 first subscriber identifier
833 second subscriber identifier
834 third subscriber identifier
835 fourth subscriber identifier
842 first switching designation
843 second switching designation
844 third switching designation
845 fourth switching designation
850 first communication link
851 second communication link
852 third communication link
853 fourth communication link
854 fifth communication link
855 sixth communication link
856 seventh communication link
860 first service
861 second service
862 third service
863 fourth service
864 first application
865 second application
866 third application
870 first service designation
871 second service designation
872 third service designation
873 fourth service designation
874 first application designation
875 second application designation
876 third application designation
880 first object collection
881 second object collection
882 third object collection
883 fourth object collection

TABLE 3
References 1000-1143

1000 first topic tree
1001 first root m
1002 first root d
1003 fifteenth topic element
1004 sixteenth topic element
1005 seventeenth topic element
1006 eighteenth topic element
1007 nineteenth topic element
1020 first route-tree layer
1021 second topic tree section
1022 third topic tree section
1023 fourth topic tree section
1024 fifth topic tree section
1025 first topic tree section
1031 first route topic element e
1032 second route topic element f
1033 third route topic element g
1034 fourth route topic element h
1035 first stop topic element
1036 second stop topic element
1037 third stop topic element
1038 fourth stop topic element
1100 second topic tree
1101 second root m
1102 second root 1
1103 second root d
1120 second route-tree layer
1121 sixth topic tree section
1122 seventh topic tree section
1123 eight topic tree section
1124 ninth topic tree section
1130 fifth route topic element e
1131 sixth route topic element f
1132 seventh route topic element g
1133 eighth route topic element h
1141 fifth stop topic element
1142 sixth stop topic element
1143 seventh stop topic element

TABLE 4
References 1200-2005

1200 first group
1201 first set
1202 second set
1211 first subscription list
1212 first translation table
1213 second translation table
1221 second subscription list
1222 third translation table
1223 fourth translation table
1231 first topic filter “m/#”
1232 second topic filter “d/e/#”
1233 third topic filter “m/#”
1234 fourth topic filter “d/e//#”
1235 fifth topic filter “l/m”
1236 sixth topic filter
1237 seventh topic filters
1238 eighth topic filter “l/#”
1239 ninth topic filter “d/e//#”
1240 tenth topic filter “d/#”
1241 eleventh topic filter “d/e/#”
1242 twelfth topic filter “m/#”
1243 thirteenth topic filter “d/e/#”
1244 fourteenth topic filter “m/#”
1245 fifteenth topic filter “d/e//#”
1246 sixteenth topic filter “l/#”
1247 seventeenth topic filter “d/e/#”
1248 eighteenth topic filter “d/#”
1249 nineteenth topic filter “l/#”
1250 twentieth topic filter “d/e//#”
1251 twenty-first topic filter “d/#”
1252 twenty-second topic filter “d/e/#”
1261 first input side
1262 first output side
1263 second input side
1264 second output side
1265 third input side
1266 third output side
1267 fourth input side
1268 fourth output side
1801 second message copy
1802 third message copy
1803 fourth message copy
1804 fourth service availability message
1805 fifth message copy
1806 first message copy
1901 third application request message
1902 sixth message copy
1903 seventh news copy
1904 first application request message
1905 eighth message copy
2001 second fourth-service response message
2002 tenth message copy
2003 eleventh message copy
2004 first fourth-service response message
2005 ninth message copy

What is claimed is:

1. An automation system comprising:
a communication infrastructure comprising a plurality of communication subscribers which are each connected to at least one message broker via a communication link;
wherein the communication subscribers are configured to publish messages under topic names or to subscribe to messages under topic names with the message broker,
wherein the communication subscribers have a subscription to availability messages with the message broker, said messages indicating that a communication subscriber is providing a service,
wherein the availability messages each comprise a first return route description which, during transmission between the communication subscribers via the communication links to the message broker, is extended in each case with a route section designation for the route sections covered, and
wherein an interaction takes place between the communication subscribers in which at least a first communication subscriber which has subscribed to messages under a first topic name with the message broker publishes an availability message under the first topic name with the message broker, indicating that the first communication subscriber is providing a service associated with the first topic name;
wherein each further communication subscriber receives a message copy of the availability message with a first return route description, which comprises the route section designations for the route sections traveled starting from the first communication subscriber, in which at least one second communication subscriber publishes a request message for the service under the first topic name with the message broker, the second communication subscriber using the first return route description of the message copy of the availability message of the service as the delivery route in the request message to the first communication subscriber, the delivery route of the request message being reduced by the route section designation of the route section traveled in each case during transmission from the second communication subscriber to the first communication subscriber via the communication links to the message broker.

2. The automation system according to claim 1, wherein:
the second communication subscriber has subscribed to messages under a second topic name with the message broker,
wherein the request message comprises a second return route description, which is extended by the route section designation of the route section traveled in each case during transmission from the second communication subscriber to the first communication subscriber via the communication links to the message broker, and
wherein the first communication subscriber publishes a response message from the service to the request message under the second topic name with the message broker;
wherein the first communication subscriber uses the second return route description of the request message as the delivery route in the response message to the second communication subscriber, and
wherein the delivery route of the response message is reduced by the route section designation of the traveled route section during transmission from the first communication subscriber to the second communication subscriber via the communication links to the message broker.

3. The automation system according to claim 1, wherein:
the availability message comprises first metadata and a first message content,
wherein the first metadata comprises the first topic name, the first return route description and a unique value, and
wherein the first message content comprises a service type and optionally a service version.

4. The automation system according to claim 1, wherein:
each communication subscriber comprises a subscriber message broker connected to the message broker via the associated communication link, and
wherein each subscriber message broker is associated with a broker designation that uniquely identifies the subscriber message broker with respect to the further subscriber message brokers connected to the message broker.

5. The automation system according to claim 4, wherein:
the communication subscriber comprises a service and/or an application, each of which is connected to the subscriber message broker of the communication subscriber via a communication link, and
wherein the service and/or the application are configured to publish messages under topic names or to subscribe to messages under topic names at the subscriber message broker of the communication subscriber.

6. The automation system according to claim 5, wherein in the communication subscriber each service is assigned a service designation and each application is assigned an application designation, which uniquely designate the service or the application in the communication subscriber.

7. The automation system according to claim 1, wherein:
the communication links of the communication subscribers to the message broker are each switching bridges, and
wherein each switching bridge is assigned a bridge designation which uniquely identifies the switching bridge with respect to the further switching bridges which are connected to the message broker.

8. The automation system according to claim 7, wherein:
the switching bridges comprise subscriptions and translation tables,
wherein the switching bridges are configured to use the subscriptions to subscribe to topic names at the subscriber message brokers connected to the switching bridges to be forwarded by the switching bridges, and
wherein the switching bridges are configured to use the translation tables to modify the topic names upon transmission.

9. The automation system according to claim 1, wherein the message broker comprises a topic tree in which a distinction is made between topic names that contain a delivery route and those that do not contain a delivery route.

10. The automation system according to claim 9, wherein the delivery route is part of the topic name in each case.

11. The automation system according to claim 9, wherein availability messages are identified in the topic tree.
